(19) United States
(12) Patent Application Publication
(10) Pub. No.: US 2014/0320898 A1
(43) Pub. Date: Oct. 30, 2014

(54) INFORMATION PROCESSING TERMINAL, INFORMATION PROCESSING SYSTEM, PRINTING APPARATUS, CONTROL METHOD FOR INFORMATION PROCESSING TERMINAL, AND CONTROL METHOD FOR PRINTING APPARATUS

(71) Applicant: Canon Kabushiki Kaisha, Tokyo (JP)

(72) Inventor: Sumi Koda, Yokohama-shi (JP)

(21) Appl. No.: 14/211,842

(22) Filed: Mar. 14, 2014

(30) Foreign Application Priority Data
Mar. 25, 2013 (JP) 2013-062861

(51) Int. Cl. G06F 3/12

(52) U.S. Cl. CPC G06F 3/125; G06F 3/1292
USPC 358/1.15

(57) ABSTRACT

Orientation information related to a orientation of an information processing terminal is acquired. Based on the orientation information, print setting related to a printing apparatus is decided on. Based on the print setting, a print job is generated. The print job is transmitted to the printing apparatus via a communication unit.

### BACKGROUND OF THE INVENTION

1. Field of the Invention

The present invention relates to an information processing system for transmitting and receiving information via wireless communication.

2. Description of the Related Art

Due to the recent spread of smartphones and other mobile terminals, there have been an increasing number of use cases in which documents and photographs are printed without using an information processing apparatus, such as a PC. There are techniques to facilitate printing from a mobile terminal using NFC (near field communication). According to these techniques, a mobile terminal is first connected to a printing apparatus via NFC, and then a document displayed on a screen of the mobile terminal is printed (Japanese Patent No. 4989544).

While the technique described in Japanese Patent No. 4989544 designates a document displayed on a screen of a mobile terminal as a print target, it is considered that print setting needs to be configured on a setting screen and the like, and usability has not been particularly improved.

### SUMMARY OF THE INVENTION

The present invention has been made to solve the above problem, and provides an information processing technique that enables intuitive print setting.

An information processing terminal according to the present invention achieves the above aim. Specifically, the information processing terminal is provided with a communication unit, and includes: an acquisition unit that acquires orientation information related to an orientation of the information processing terminal; a decision unit that decides on print setting related to a printing apparatus based on the orientation information; a generation unit that generates a print job based on the print setting; and a transmission unit that transmits the print job to the printing apparatus via the communication unit.

Further features of the present invention will become apparent from the following description of exemplary embodiments with reference to the attached drawings.

### BRIEF DESCRIPTION OF THE DRAWINGS

FIG. 1 schematically shows a configuration of an information processing system according to a first embodiment.

FIG. 2 is a block diagram showing a schematic configuration of a smartphone according to the first embodiment.

FIG. 3 is a block diagram showing a schematic configuration of a printing apparatus according to the first embodiment.

FIG. 4 is a state transition diagram for NFC activities according to the first embodiment.

FIG. 5A shows the state where the smartphone according to the first embodiment is displaying a print preview.

FIG. 5B shows the state where the smartphone according to the first embodiment is displaying a print preview.

FIG. 6A shows a postcard and the printing apparatus according to the first embodiment.

FIG. 6B shows the postcard and the printing apparatus according to the first embodiment.

FIG. 6C shows the postcard and the printing apparatus according to the first embodiment.

FIG. 6D shows the postcard and the printing apparatus according to the first embodiment.

FIG. 6E shows the postcard and the printing apparatus according to the first embodiment.

FIG. 7A is a diagram for describing a tilt of the smartphone according to the first embodiment.

FIG. 7B is a diagram for describing the tilt of the smartphone according to the first embodiment.

FIG. 8 shows a correspondence table for deciding on a rotation parameter in the first embodiment.

FIG. 9 is a flowchart showing processing executed by the smartphone according to the first embodiment.

FIG. 10 is a flowchart showing print setting configured by the smartphone in the first embodiment.

FIG. 11 is a flowchart showing processing executed by the printing apparatus according to the first embodiment.

FIG. 12 shows a result of conducting printing on the postcard in the first embodiment.

FIG. 13 shows a correspondence table for deciding on a sheet direction in a second embodiment.

FIG. 14 shows a print-target document and an exemplary result of printing according to the second embodiment.

FIG. 15 is a flowchart showing print setting configured by the smartphone in the second embodiment.

FIG. 16 shows a correspondence table for deciding on color setting in a third embodiment.

FIG. 17 is a flowchart showing print setting configured by the smartphone in the third embodiment.

### DESCRIPTION OF THE EMBODIMENTS

Embodiments of the present invention will be described below in detail with reference to the drawings.

### First Embodiment

A target of a first embodiment is a use case in which a user is expected to print an address on a postcard using a smartphone. The user causes the smartphone to display a print preview of an address side while holding the smartphone in portrait direction. Thereafter, the user tilts the smartphone so as to make the direction of the postcard placed on a feeding tray of a printing apparatus coincide with the direction of the print preview, and then brings the smartphone into contact with the printing apparatus. In the aforementioned action of the user, application of the present invention makes it possible to achieve a printing result desired by the user.

The following is a detailed description of the present system.

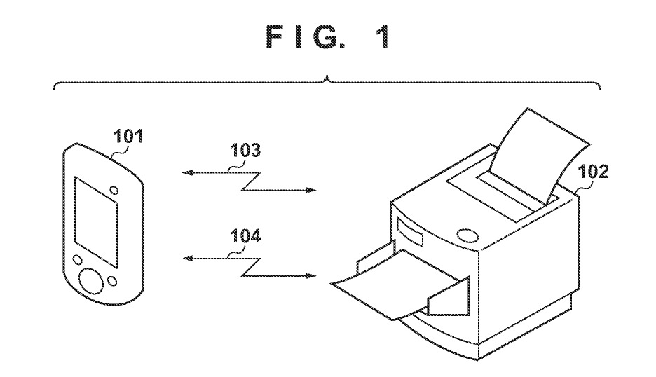

FIG. 1 schematically shows an information processing system according to the first embodiment.

This system includes a smartphone 101 as an information processing terminal and a printing apparatus 102 as an information processing apparatus. The information processing terminal may be a tablet PC or another terminal apparatus instead of a smartphone. The smartphone 101 and the printing apparatus 102 can perform short range wireless communication, such as NFC 103. The smartphone 101 and the printing apparatus 102 can also transmit and receive data via network (N/W) communication 104.

A communication range of NFC is said to be within a range of a predetermined distance (less than 10 centimeters), and NFC 103 can be established by the user bringing the smartphone 101 and the printing apparatus 102 into proximity to each other such that a distance therebetween is less than 10 centimeters. On the other hand, NFC 103 can be disconnected by the user moving the smartphone 101 away from the printing apparatus 102 to the outside of the communication range of NFC. In this way, NFC 103 between the smartphone 101 and the printing apparatus 102 can be established and disconnected through a simple user operation of moving the smartphone 101 and the printing apparatus 102 into proximity to each other or away from each other. By using such characteristics, it is possible to execute processing based on a positional relationship between the smartphone 101 and the printing apparatus 102.

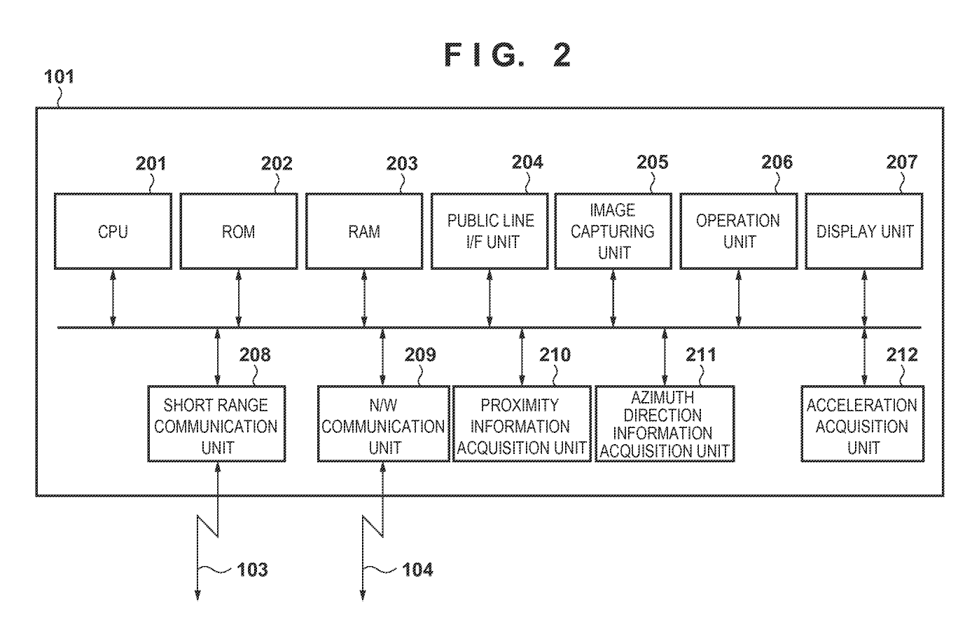

FIG. 2 shows a schematic configuration of the smartphone 101 according to the first embodiment.

A CPU 201 is a central processing unit that controls the entirety of the smartphone 101. Processing for input information accepted by an operation unit 206, as well as display control for executing processing for outputting a display image to a display unit 207, are also realized by processing of the CPU 201. Programs and fixed data for realizing later-described flowcharts are stored in a ROM 202, and a RAM 203 is used in temporarily storing data and loading programs.

A public line I/F unit 204 enables the smartphone 101 to connect to other communication/telephone apparatuses via a telephone line for communication/calling purposes. An image capturing unit 205 includes an image capture lens and an image sensor, and generates image data by capturing an image of a subject. The operation unit 206 includes operation buttons and a touchscreen, and accepts user input with respect to the smartphone 101 via button operations and the touchscreen. The display unit 207 includes a display and displays UI information including images and text data corresponding to the contents of processing.

A short range communication unit 208 includes an NFC chip (IC chip compatible with the NFC standards), and controls transmission and reception of data by establishing communication connection with external apparatuses via NFC 103. An N/W communication unit 209 can establish communication connection via the network (N/W) communication 104. Either a wireless or wired communication method may be adopted. A proximity information acquisition unit 210 includes a proximity sensor that detects a change in capacitance, and can detect the state where the smartphone 101 is in proximity to something (proximity state). The proximity information acquisition unit 210 may use a luminance sensor that detects brightness instead of the proximity sensor. The luminance sensor detects the state where the smartphone 101 is in proximity to something by detecting a dark state (for example, the state of luminance equal to or lower than predetermined luminance).

An azimuth direction information acquisition unit 211 includes a magnetic sensor that detects the earth's magnetic field, and can acquire the azimuth direction (direction) in which the smartphone 101 is facing. An acceleration acquisition unit 212 includes an acceleration sensor, and can acquire an angle of elevation (tilt) of the smartphone 101 with respect to a horizontal plane by detecting the direction of gravitational acceleration (for example, m/s²). Orientation information indicating the direction, tilt, and the like of the smartphone 101 is detected and calculated by one of the proximity information acquisition unit 210, the azimuth direction information acquisition unit 211 and the acceleration acquisition unit 212 in the smartphone 101, or by any combination thereof.

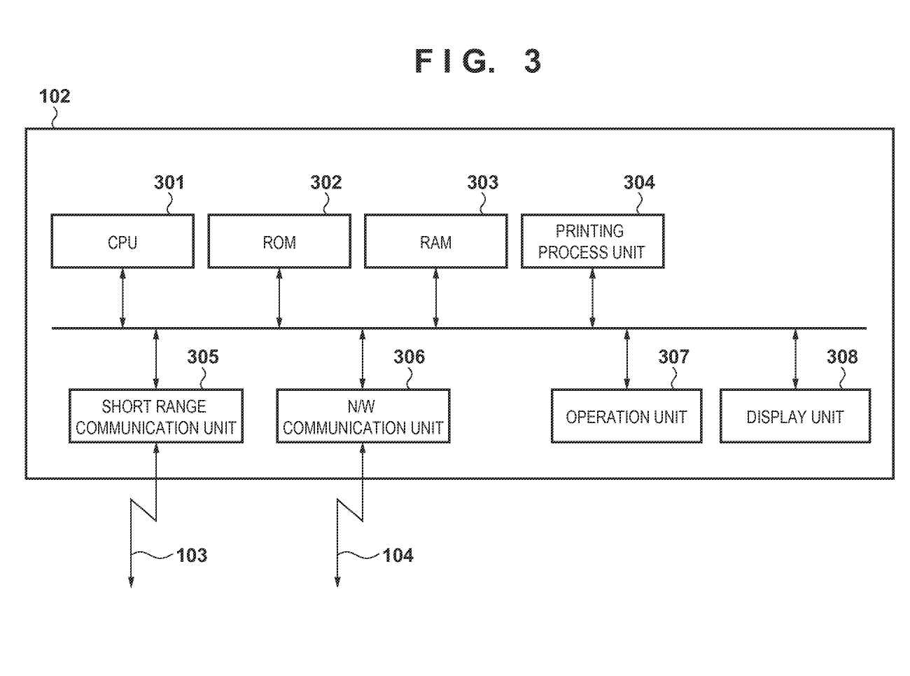

FIG. 3 shows a schematic configuration of the printing apparatus 102 according to the first embodiment.

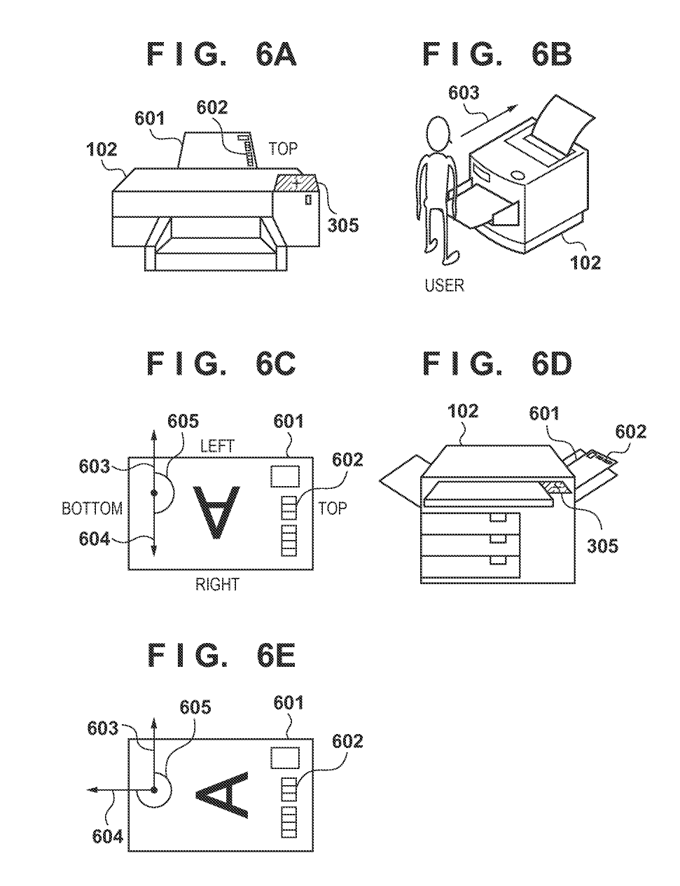

A CPU 301 is a central processing unit that controls the entirety of the printing apparatus 102, and performs overall control of processing sequences of the printing apparatus 102. Programs and fixed data for realizing later-described flowcharts are stored in a ROM 302, and a RAM 303 is used in temporarily storing data and loading programs. The fixed data stored in the ROM 302 includes directions 605 of print images (FIGS. 6C and 6E) for respective feeding trays (feeding units), which will be described later. Data stored in the RAM 303 includes information of recording mediums set in the feeding trays.

A printing process unit 304 controls the printing apparatus 102, which can implement an inkjet/laser printing method, and executes print processing for a print job. A print job includes image data and print setting. Print setting includes parameters necessary for print processing, a job name, a user name, and the like. A short range communication unit 305 includes an NFC chip, and controls transmission and reception of data by establishing communication connection with the smartphone 101 via NFC 103. An N/W communication unit 306 can establish communication connection via the network (N/W) communication 104. Either a wireless or wired communication method may be adopted.

An operation unit 307 accepts user input with respect to the printing apparatus 102 via button operations and a touchscreen. A display unit 308 includes a display, such as an LCD (liquid crystal display), and displays images and text data corresponding to the contents of processing of the printing apparatus 102.

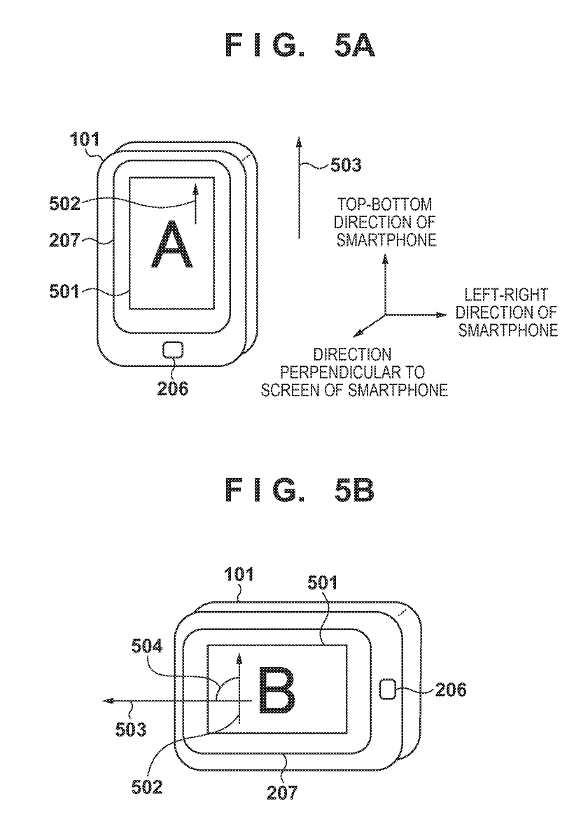

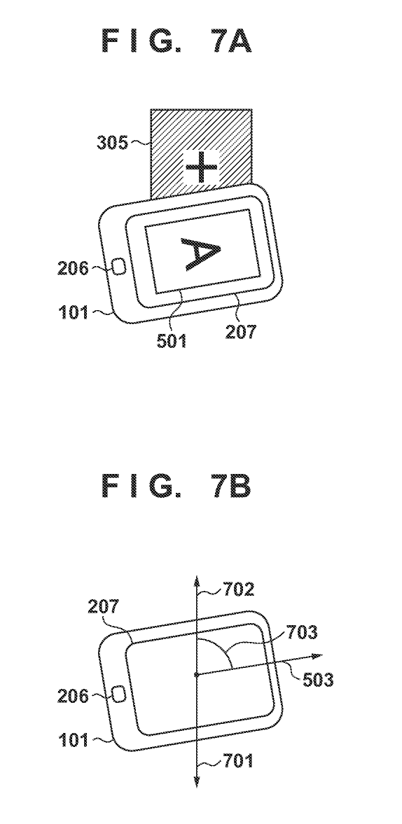

The first embodiment provides a description of a system for deciding on print setting based on orientation information of the smartphone 101 and on apparatus information of the printing apparatus 102 (including, for example, a feeding state of a recording medium stored in a feeding unit of the printing apparatus 102 and the direction of a print image). Specifically, a description is given of an example in which a rotation parameter is decided on from a correspondence table 801 based on a value calculated from a rotation angle 504 (FIG. 5B) of a print preview 501 (FIG. 5A) displayed on the display unit 207 of the smartphone 101 and a tilt 703 (FIG. 7B) of the smartphone 101, and on the direction 605 of a print image (FIGS. 6C and 6E) of the printing apparatus 102, as shown in FIGS. 5A to 7B.

It should be noted that the rotation angle 504 of the print preview 501 is a relative angle between a top direction 503 of the smartphone 101 and a top direction 502 of the print preview 501. The tilt 703 of the smartphone 101 is a rotation angle formed by rotating the smartphone 101 about an axis along a direction perpendicular to a screen of the display unit 207. The direction 605 of a print image is the direction of an image printed on a recording medium (sheet) placed on a feeding tray. A detailed description will be provided below with reference to FIGS. 5A, 5B, and 6A to 6E.

FIGS. 5A and 5B show the states where the smartphone 101 is displaying the print preview 501. The rotation angle 504 of the print preview 501 will be described with reference to these figures.

A description is now given of the print preview 501 and the top direction 503 of the smartphone 101 with reference to FIG. 5A. The print preview 501 is displayed on the display unit 207 of the smartphone 101. The print preview 501 is obtained by rendering an image of a result of conducting printing on a print-target document, and displays the entirety of an arbitrary page. Furthermore, when the print preview 501 is displayed, print setting such as a sheet size and a sheet direction, as well as rotation of the screen, are locked. The top direction 502 of the print preview 501 is the same as a top direction of the print-target document.

Next, a description is given of the top direction 503 of the smartphone 101. Top, bottom, left, and right of the smartphone 101 coincide with top, bottom, left, and right defined by the acceleration acquisition unit 212, respectively. The acceleration acquisition unit 212 includes three axes along the following directions of the smartphone 101, and can detect accelerations along the respective axes (directions): the top-bottom direction, the left-right direction, and the direction perpendicular to the screen. In the first embodiment, a vector from a bottom edge to a top edge in the state where the user is holding the smartphone 101 in portrait direction is regarded as the top direction 503 of the smartphone 101.

A description is now given of the rotation angle 504 of the print preview 501 with reference to FIG. 5B. The print preview 501 is displayed on the display unit 207 of the smartphone 101. The rotation angle 504 of the print preview 501 is defined as a value indicating a degree at which the top direction 502 of the print preview 501 has rotated clockwise with respect to a reference, that is to say, the top direction 503 of the smartphone 101.

In FIG. 5B, the top direction 502 of the print preview 501 has rotated by 90 degrees clockwise with respect to the reference, i.e., the top direction 503 of the smartphone 101; therefore, the rotation angle 504 of the print preview 501 is 90 degrees. On the other hand, in FIG. 5A, the top direction 503 of the smartphone 101 coincides with the top direction 502 of the print preview 501; therefore, the rotation angle 504 of the print preview 501 is 0 degrees.

FIGS. 6A to 6E show the printing apparatus 102 and a postcard 601 according to the first embodiment. The definition of the direction 605 of a print image will be described below with reference to these figures.

Top, bottom, left, and right of the postcard 601 will now be described with reference to FIG. 6A. FIG. 6A shows the printing apparatus 102 and the postcard 601 placed on a feeding tray. The short range communication unit 305 may be arranged in a position that allows the user who stands in front of the printing apparatus 102 to easily check the orientation of the smartphone 101 that is in proximity to the short range communication unit 305. It is the nature of the postcard 601 and similar recording mediums to have a top-bottom direction. For the sake of explanation, top, bottom, left, and right of the postcard 601 are defined with a side provided with a postal code field 602 being regarded as top. In FIG. 6A, the postcard 601 is placed on the feeding tray in such a manner that the top direction of the postcard 601 is directed toward the right side when viewed from the front of the printing apparatus 102.

A description is now given of a vector 603 that serves as a reference necessary for defining the direction 605 of a print image with reference to FIG. 6B. As shown in FIG. 6B, the vector 603 serving as the reference is a direction from the front to the back, that is to say, a direction from a front side to a rear side of the printing apparatus 102, when the user views the recording medium while standing in front of the printing apparatus 102.

The direction 605 of a print image will now be described with reference to FIG. 6C. FIG. 6C shows a result of conducting printing on the postcard 601 that has been fed by the printing apparatus 102 as shown in FIG. 6A without executing rotation processing for a print-target document. As shown in FIG. 6C, the direction 605 of the print image is defined as a value indicating a degree at which a top direction 604 of an image drawn on the recording medium has rotated clockwise with respect to the vector 603 serving as the reference when the recording medium on which printing was conducted without executing the rotation processing is returned to its pre-printing feeding state.

In FIG. 6C, the vector 603 serving as the reference extends from the right to the left of the postcard 601, whereas the top direction 604 of the image drawn on the recording medium extends from the left to the right of the postcard 601. The direction 605 of the print image is a clockwise rotation angle between the vector 603 serving as the reference and the top direction 604 of the image drawn on the recording medium, that is to say, 180 degrees in FIG. 6C.

Note that the direction 605 of the print image takes unique values for respective feeding units of the printing apparatus 102. The description of the first embodiment is targeted for the printing apparatus 102 with which the direction 605 of the print image takes one of the following values: 0 degrees, 90 degrees, 180 degrees, and 270 degrees. As unique values are taken for respective feeding units, the following situation may occur: while the direction 605 of the print image for the feeding tray of the printing apparatus 102 shown in FIG. 6A is 180 degrees, the direction 605 of the print image for a feeding cartridge (drawer) is 0 degrees. Although the direction 605 of the print image is the direction of an image printed on a recording medium placed on a feeding tray in the first embodiment, it may instead be the direction of an image printed on a recording medium discharged on a discharge tray.

A supplementary description of the direction 605 of the print image will be provided below with reference to FIGS. 6D and 6E.

FIG. 6D shows the printing apparatus 102 and the postcard 601 placed on a feeding tray. Unlike the printing apparatus 102 shown in FIG. 6A, the printing apparatus 102 shown in FIG. 6D feeds a recording medium placed on the feeding tray from the right to the left when viewed from the front. The postcard 601 shown in FIG. 6D is placed in such a manner that the top direction of the postcard 601 is directed toward the right side when viewed from the front of the printing apparatus 102.

The postcard 601 shown in FIG. 6E is a result of conducting printing on the postcard 601 that has been fed as shown in FIG. 6D without executing rotation processing for a print-target document. The vector 603, which serves as a reference in defining the direction 605 of the print image, extends from the right to the left of the postcard 601, whereas the top direction 604 of the image drawn on the recording medium extends from the top to the bottom of the postcard 601. The direction 605 of the print image is a clockwise rotation angle between the vector 603 serving as the reference and the top direction 604 of the image drawn on the recording medium, that is to say, 270 degrees in FIG. 6E.

FIGS. 7A and 7B show a relationship between the short range communication unit 305 and the smartphone 101 in the first embodiment. The following describes the definition of the tilt 703 of the smartphone 101 with reference to these figures.

FIG. 7A shows the short range communication unit 305 and the smartphone 101 that are in proximity to each other.

In the first embodiment, the user causes the display unit 207 to display the print preview 501 as shown in FIG. 5A by operating the operation unit 206 of the smartphone 101. Next, the smartphone 101 is tilted in such a manner that the top direction of the postcard 601 coincides with the top direction 503 of the smartphone 101, and then brought into contact with the short range communication unit 305 in this tilted state.

The tilt 703 of the smartphone 101 will now be described with reference to FIG. 7B. A vector 701 is obtained by projecting a gravitational acceleration vector acquired by the acceleration acquisition unit 212 onto a surface of the display unit 207 of the smartphone 101. A vector 702 extends in a direction opposite to the direction of the vector 701. The tilt 703 of the smartphone 101 is an angle of clockwise rotation from the vector 702 to the top direction 503 of the smartphone 101. A contact surface of the short range communication unit 305 may be arranged with a certain degree of tilt with respect to a horizontal plane so as to facilitate detection of the vector 701 when it is in proximity to the smartphone 101.

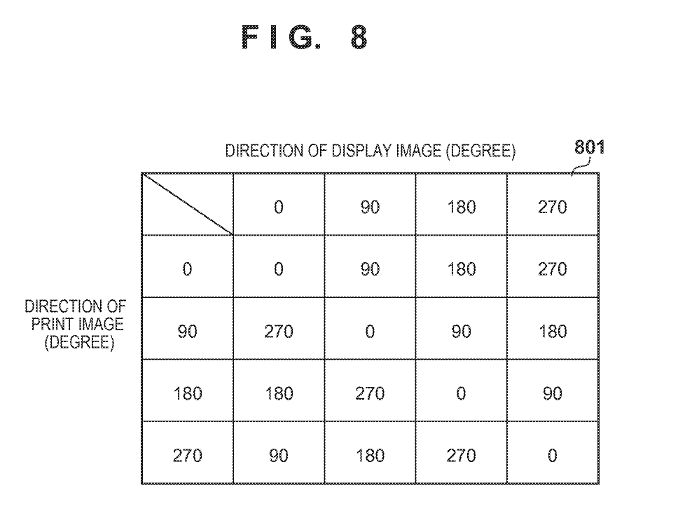

FIG. 8 shows an example of a correspondence table showing the correspondence among rotation parameters based on the direction of a display image and on the direction 605 of a print image in the first embodiment.

The direction of the display image is a sum of the rotation angle 504 of the print preview 501 and the tilt 703 of the smartphone 101. When the direction of the display image exceeds 360 degrees, the value thereof is divided by 360, and the resultant remainder is used as the direction of the display image. A rotation parameter, which is a part of the print setting that specifies a layout of the print image to be printed on the recording medium, designates an amount of clockwise rotation with respect to image data, and a unit thereof is a degree. Rows and columns of the correspondence table 801 indicate the direction 605 of the print image and the direction of the display image, respectively.

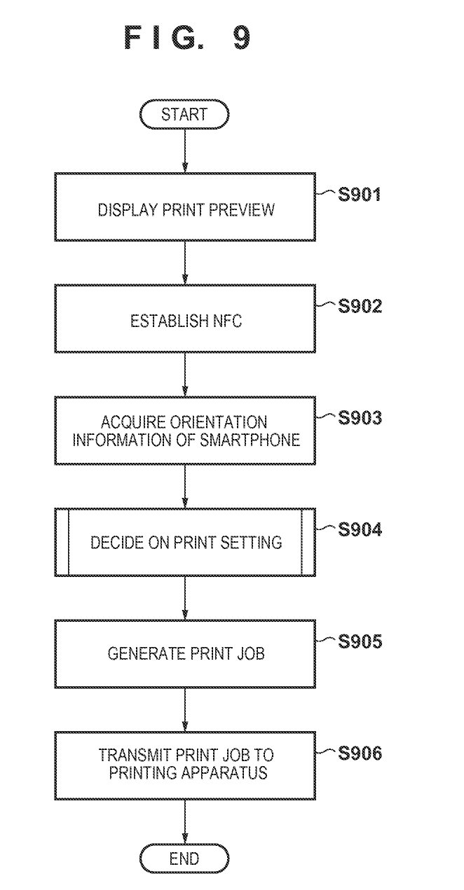

FIG. 9 shows a processing flow of the smartphone 101 according to the first embodiment. Prior to the start of the processing flow of FIG. 9, the user views and edits a print-target document on the display unit 207 of the smartphone 101. It will be assumed that, while a screen for viewing and editing is displayed, it is rotated in accordance with the acceleration sensor of the acceleration acquisition unit 212.

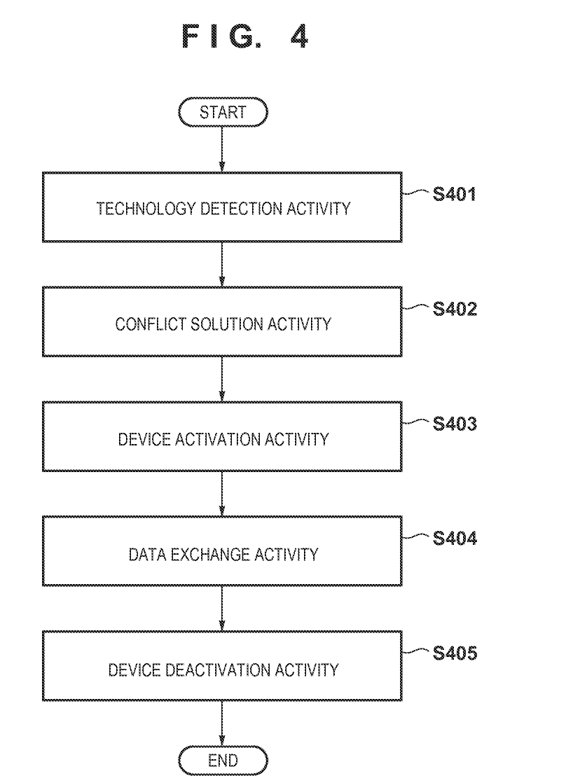

In step S901, the CPU 201 accepts an operation for displaying the print preview from the operation unit 206, displays the print preview 501 on the display unit 207 as shown in FIGS. 5A and 5B, and locks the rotation of the screen. Furthermore, the CPU 201 stores the rotation angle 504 of the print preview 501 in the RAM 203. In step S902, the CPU 201 detects proximity between the short range communication unit 208 of the smartphone 101 and the short range communication unit 305 of the printing apparatus 102 and establishes connection via NFC 103 through processing shown in FIG. 4, which will be described later.

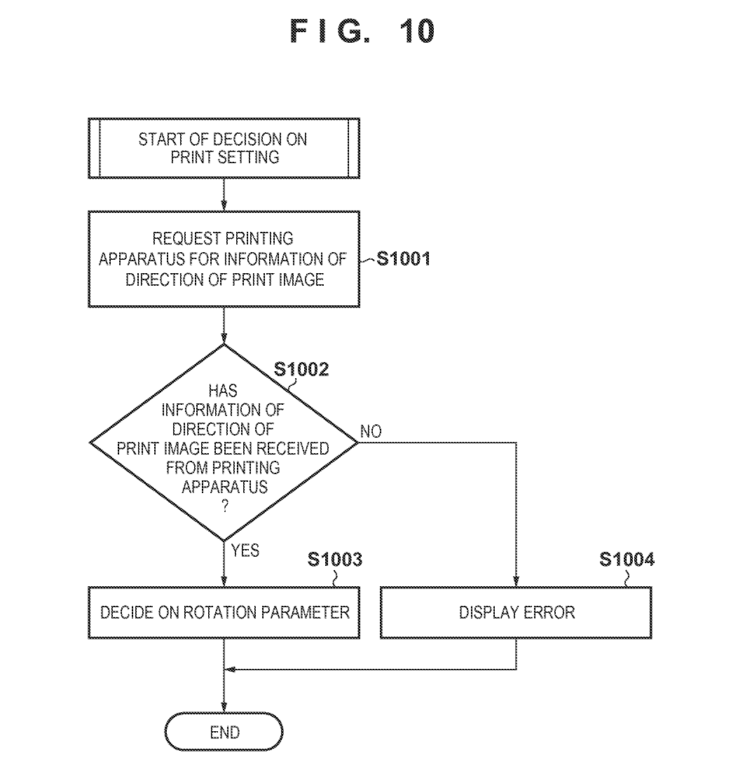

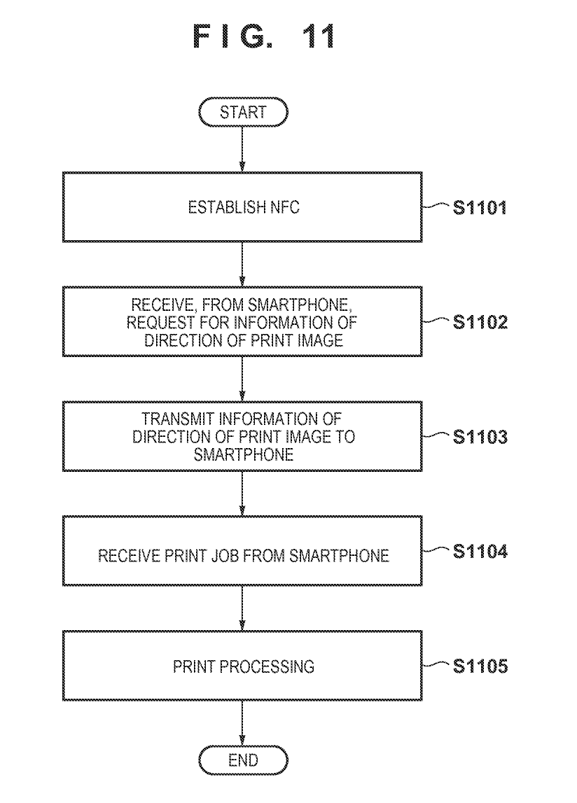

In step S903, the CPU 201 acquires the tilt 703 of the smartphone 101 as orientation information based on the acceleration acquired from the acceleration acquisition unit 212. In step S904, the CPU 201 decides on print setting in accordance with a print decision flow of FIG. 10, which will be described later.

In step S905, the CPU 201 acquires image data displayed on the display unit 207 from the RAM 203, and generates a print job in consideration of the print setting that was decided on in step S904. In step S906, the CPU 201 transmits the print job generated in step S905 to the printing apparatus 102 via the short range communication unit 208.

FIG. 10 shows a flow in which the smartphone 101 decides on the print setting in step S904.

In step S1001, the CPU 201 requests the printing apparatus 102 for information of the direction 605 of the print image via the short range communication unit 208. In step S1002, the CPU 201 determines whether or not the information of the direction 605 of the print image was able to be received from the printing apparatus 102 via the short range communication unit 208. Note that steps S1001 and S1002 correspond to step S404 shown in FIG. 4, which will be described later.

If the information of the direction 605 of the print image is not able to be received from the printing apparatus 102 (NO of step S1002), the CPU 201 displays, on the display unit 207, error information (an image, text data, etc.) indicating that apparatus information (the information of the direction 605 of the print image) is not able to be received from the printing apparatus 102 in step S1004, and ends processing.

On the other hand, if the information of the direction 605 of the print image was able to be received from the printing apparatus 102 (YES of step S1002), the CPU 201 refers to the rotation angle 504 of the print preview 501 in the RAM 203, adds the same to the tilt 703 of the smartphone 101 acquired in step S903, and uses the result of the addition as the direction of the display image in step S1003. Furthermore, the CPU 201 decides on a rotation parameter from the correspondence table 801 of FIG. 8 based on the direction of the display image and on the direction 605 of the print image received in step S1002.

Note that the tilt 703 of the smartphone 101 acquired in step S903 is rounded to one of 0 degrees (360 degrees), 90 degrees, 180 degrees, and 270 degrees that is closest thereto, and used for the correspondence table 801. The following describes a specific example of the rotation parameter acquired in step S1003. It will be assumed that the user conducts printing on the printing apparatus 102 under the condition that the direction 605 of the print image is 180 degrees. While the smartphone 101 is displaying the print preview 501 with the rotation angle 504 of 0 degrees, the user tilts the smartphone 101 such that the tilt 703 thereof is 80 degrees and brings it into contact with the printing apparatus 102 in this tilted state. The value of the tilt 703 of the smartphone 101, i.e., 80 degrees is rounded to 90 degrees and added to the rotation angle 504 of the print preview 501, i.e., 0 degrees; as a result, the direction of the display image is decided as 90 degrees. Based on the direction of the display image, i.e., 90 degrees and on the direction 605 of the print image, i.e., 180 degrees, 270 degrees is decided as the rotation parameter in accordance with the correspondence table 801.

FIG. 11 shows a processing flow of the printing apparatus 102 according to the first embodiment.

In step S1101, the CPU 301 detects proximity between the short range communication unit 208 of the smartphone 101 and the short range communication unit 305 of the printing apparatus 102 and establishes connection via NFC 103 through steps S401 to S403 shown in FIG. 4, which will be described later. In step S1102, the CPU 301 receives the request made by the smartphone 101 for the information of the direction 605 of the print image via the short range communication unit 305.

In step S1103, the CPU 301 acquires the direction 605 of the print image from the ROM 302 and transmits the same to the smartphone 101 via the short range communication unit 305. Note that steps S1102 and S1103 correspond to step S404 shown in FIG. 4, which will be described later. In step S1104, the CPU 301 receives the print job from the smartphone 101 via the short range communication unit 305. In step S1105, the CPU 301 executes print processing based on the print job that was received in step S1104 by the printing process unit 304 after executing rotation processing with reference to the rotation parameter included in the print job.

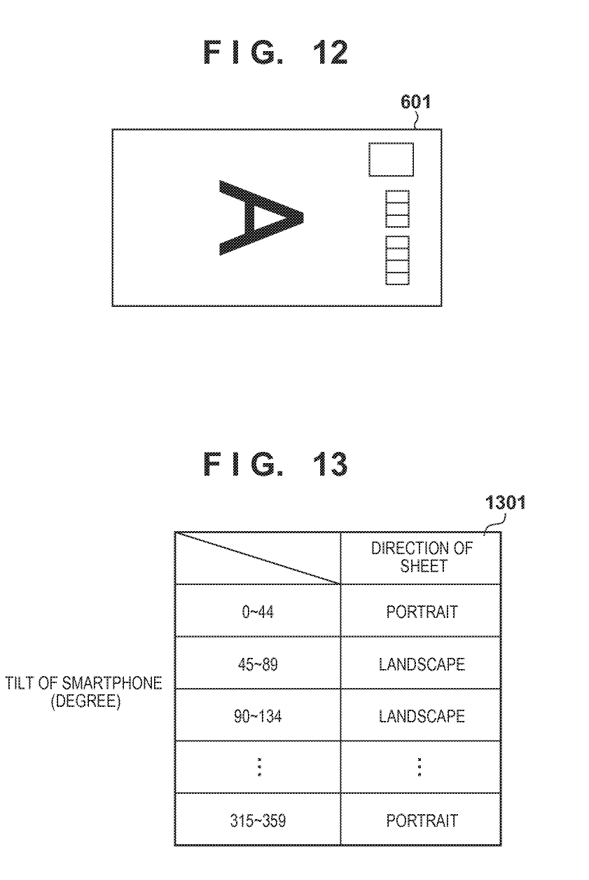

FIG. 12 shows an example of a result of printing.

It will be assumed that, as shown in FIG. 6A, the postcard 601 is placed in such a manner that the top direction thereof is directed toward the right side when viewed from the front of the printing apparatus 102. The following describes an example of the printing apparatus 102 that can obtain the postcard 601 shown in FIG. 6C as a result of printing if the printing is conducted without executing the rotation processing, which represents the characteristics of the present invention. The direction 605 of the print image for the feeding tray of the printing apparatus 102 on which the postcard 601 is placed is 180 degrees. In this situation, as shown in FIG. 7A, the user tilts the smartphone 101 such that the tilt 703 thereof is 90 degrees, and brings the smartphone 101 into proximity to the printing apparatus 102 in this tilted state. It will be assumed that the rotation angle 504 of the print preview 501 is 0 degrees at this time. As a result, 270 degrees is decided as the rotation parameter through the process of step S1003. By rotating an image to be drawn on the postcard 601 of FIG. 6C clockwise by the rotation parameter, i.e., 270 degrees, the postcard 601 shown in FIG. 12 is obtained as a result of printing.

As another example, the following describes an example of the printing apparatus 102 that can obtain the postcard 601 shown in FIG. 6E as a result of printing if the printing is conducted without executing the rotation processing, which represents the characteristics of the present invention. The postcard 601 is placed in such a manner that the top direction thereof is directed toward the right side when viewed from the front of the printing apparatus 102, as shown in FIG. 6D, and the direction 605 of the print image for the feeding tray of the printing apparatus 102 is set to 270 degrees. In this situation, as shown in FIG. 7A, the user tilts the smartphone 101 such that the tilt 703 thereof is 90 degrees, and brings the smartphone 101 in proximity to the printing apparatus 102 in this tilted state. It will be assumed that the rotation angle 504 of the print preview 501 is 0 degrees. Through the process of step S1003, 180 degrees is acquired as the rotation parameter. By rotating an image to be drawn on the postcard 601 of FIG. 6E clockwise by the rotation parameter, i.e., 180 degrees, the postcard 601 shown in FIG. 12 is obtained as a result of printing.

In the first embodiment, a feeding unit targeted for printing may always be in a fixed relationship with a feeding tray, or the user may register a specific feeding unit used in the printing via the operation unit 206 and the operation unit 307.

If the size and direction of a sheet included in the print job received in step S1104 do not match the size and direction of a recording medium that is being fed, the CPU 301 may output a sheet size error in step S1105. If the user instructs the printing apparatus 102 to discharge a sheet forcibly using the operation unit 307, processing for scaling up/down an image may be executed so that the entire image is printed in accordance with the size of a recording medium that is being fed. Any of the following layouts may be adopted: a layout in which the center of the print image coincides with the center of the recording medium; a layout in which the print image is aligned toward one direction of the recording medium; and a layout in which a plurality of pages are arranged on the recording medium.

The CPU 201 may communicate with (transmit and receive information to and from) the printing apparatus 102 via the N/W communication unit 209 instead of via the short range communication unit 208. The CPU 301 may communicate with (transmit and receive information to and from) the smartphone 101 via the N/W communication unit 306 instead of via the short range communication unit 305. The rotation processing executed by the printing apparatus 102 in step S1105 may be executed by the smartphone 101 in step S905.

The correspondence table 801 may be stored in the ROM 302 of the printing apparatus 102 at the time of shipping from a factory, or an apparatus-specific correspondence table may be acquired via the Internet. In this configuration, the CPU 201 of the smartphone 101 skips the process of step S904; instead, it includes the orientation information into the print job generated in step S905. Also, the CPU 301 of the printing apparatus 102 skips the processes of steps S1102 and S1103; instead, it refers to the correspondence table 801 and apparatus information in the ROM 302 and decides on a rotation parameter, which is print setting, based on the received orientation information in the print processing of step S1105.

A description is now given of establishment of connection between NFC devices provided with NFC functions. FIG. 4 is a processing flow diagram showing activities of NFC carried out in connection between the smartphone 101 and the printing apparatus 102.

In NFC processing, NFC devices realize detection of a communication target, establishment of communication, and transmission and reception of data by executing a sequence of processes called activities. In the first embodiment, it is assumed that NFC devices are apparatuses provided with IC chips compatible with the NFC standards. In the activities, a plurality of NFC devices establish communication, exchange data, and execute a termination process by transmitting and receiving commands to and from one another.

The following describes transition of activities. First, in a technology detection activity of step S401, whether or not another NFC device exists within a communication range is detected; if such an NFC device is found, the NFC type of that target device is determined via transmission and reception of a command. In a conflict solution activity of step S402, identification is performed if a plurality of NFC devices are detected. NFC devices have such modes as a P2P (peer-to-peer) mode and a CE (card emulator) mode.

In a device activation activity of step S403, a mode to which the detected target device corresponds, or a type to which an NFC tag corresponds, is identified. An NFC tag is an IC tag for which an NFC tag reader/writer can perform reading and writing. When two NFC devices that communicate with each other operate in a P2P mode, any data can be transmitted and received bi-directionally. Other than the P2P mode, NFC devices can switch to a CE mode in which they act as NFC tags and allow access from the NFC tag reader/writer, and to an R/W (reader/writer) mode in which they perform reading and writing for NFC tags. In the first embodiment, the CPU 201 and the CPU 301 both operate in the P2P mode to control communication with the short range communication unit 208 and the short range communication unit 305, respectively.

In a data exchange activity of step S404, data is transmitted and received to and from the detected target device. In this activity, any data can be transmitted and received to and from the target device. In a device deactivation activity of step S405, a process for terminating the communication is executed.

The NFC standards specify a communication mode for actively transmitting commands through the sequence of processes from steps S401 to S405 as a Poll mode. On the other hand, a mode of a device that receives commands from a device in the Poll mode is specified as a Listen mode. The first embodiment describes the case where the smartphone 101 and the printing apparatus 102 are connected in the Poll mode and the Listen mode, respectively. However, as NFC devices can generally switch between the Poll mode and the Listen mode, the same effects are achieved even if the modes of the smartphone 101 and the printing apparatus 102 are reversed. Through the aforementioned sequence of activity processes, connection via NFC 103 is established and data is transmitted and received in accordance with proximity between the NFC chip provided in the short range communication unit 305 of the printing apparatus 102 and the NFC chip provided in the short range communication unit 208 of the smartphone 101.

As described above, according to the first embodiment, the user can configure print setting for the printing apparatus 102 using the orientation of the smartphone 101 that has established NFC 103.

More specifically, according to the first embodiment, intuitive print setting can be configured by causing the top-bottom direction of an image printed on a recording medium that is fed or discharged, as viewed from the user, to coincide with the top-bottom direction of an image displayed on the smartphone 101 that has been brought into contact with the printing apparatus 102 by the user.

For example, if the printing apparatus 102 conducts printing on a recording medium stored in a cartridge (drawer), i.e., a feeding unit, the top-bottom direction of an image printed on a recording medium discharged onto a discharge tray may be used, or the top-bottom direction of an image printed on a recording medium stored in the cartridge may be used. Furthermore, if a recording medium is placed on a feeding tray such as a manual feeding tray in the printing apparatus, the top-bottom direction of an image to be printed on the recording medium placed on the feeding tray may be used. Therefore, the user can print a print-target document displayed on the smartphone 101 in a desired direction on a recording medium having a top-bottom direction (for example, the postcard 601) without paying attention to the direction 605 of a print image unique to the printing apparatus 102.

### Second Embodiment

The first embodiment has described the example in which the rotation parameter is decided on based on the tilt 703 of the smartphone 101 and on the direction 605 of a print image of the printing apparatus 102. In contrast, the second embodiment describes an example in which the direction of a sheet is decided on in accordance with the tilt 703 of the smartphone 101. It should be noted that configurations and processes that have the same functions as those of the first embodiment are given the same reference signs thereas, and a description of elements that are not different from those of the first embodiment in terms of configuration and function is omitted.

The apparatus configurations shown in FIGS. 1, 2 and 3 and the flowcharts shown in FIGS. 4 and 9 according to the first embodiment are applicable to the present embodiment. FIG. 11 is applicable to the present embodiment, except that information of a feeding state is transmitted and received in steps S1102 and S1103 instead of the information of the direction 605 of the print image.

FIG. 13 shows a correspondence table 1301 indicating the correspondence between the tilt 703 of the smartphone 101 and the direction of a sheet according to the second embodiment. In the case where the tilt 703 of the smartphone 101 is 0 degrees to 44 degrees, 135 degrees to 224 degrees, and 315 degrees to 359 degrees, portrait is decided as the direction of the sheet; in other cases, landscape is decided as the direction of the sheet.

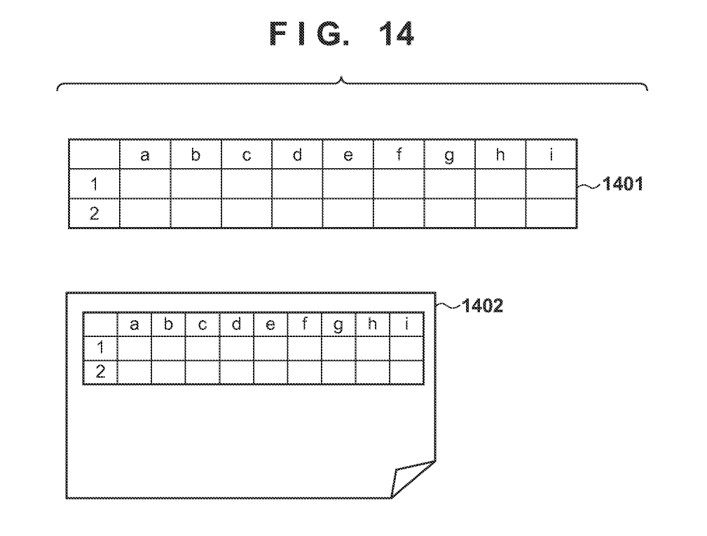

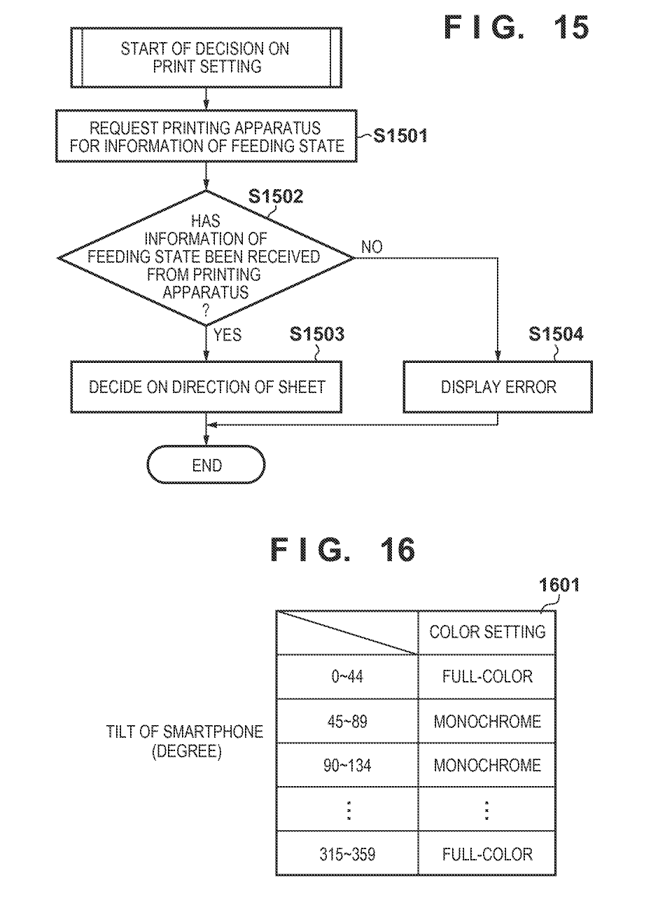

FIG. 14 shows a print-target document and a result of printing according to the second embodiment. It will be assumed that, as a print-target document 1401 shown in FIG. 14 contains more columns than lines, the user wishes to conduct printing on a recording medium 1402 in landscape direction as shown in FIG. 14.

FIG. 15 shows a flow in which the smartphone 101 decides on print setting in step S904 in the second embodiment.

In step S1501, the CPU 201 requests the printing apparatus 102 for information of a feeding state via the short range communication unit 208. The feeding state denotes the size and direction of a recording medium set in the printing apparatus. In step S1502, the CPU 201 determines whether or not the information of the feeding state was able to be received from the printing apparatus 102 via the short range communication unit 208. Note that steps S1501 and S1502 correspond to step S404 shown in FIG. 4 described earlier.

If the information of the feeding state is not able to be received from the printing apparatus 102 (NO of step S1502), the CPU 201 displays, on the display unit 207, error information (an image, text data, etc.) indicating that apparatus information (the information of the feeding state) is not able to be received from the printing apparatus 102 in step S1504, and ends processing.

On the other hand, if the information of the feeding state was able to be received from the printing apparatus 102 (YES of step S1502), the CPU 201 decides on the direction of the sheet based on the tilt 703 of the smartphone 101 acquired in step S903 and on the correspondence table 1301 in step S1503. Furthermore, if the direction of the feeding state received in step S1502 differs from the direction of the sheet that was decided on in step S1503, the CPU 201 rotates image data by 90 degrees. It should be noted that, if the direction of the feeding state received in step S1502 coincides with the direction of the sheet that was decided on in step S1503, the image data is not rotated.

In the second embodiment, the smartphone 101 is brought into proximity to the printing apparatus 102 as shown in FIG. 7A, and the tilt 703 of the smartphone 101 is 80 degrees; therefore, based on the correspondence table 1301, the direction of the sheet is decided as landscape. Furthermore, if “portrait” is acquired as the information of the feeding state in step S1502, as this is different from the direction of the sheet, and 90 degrees is set as a rotation parameter.

Furthermore, in the second embodiment, step S901 may be omitted as there is no need to display a preview screen, and processing can be executed while the screen for viewing and editing is being displayed.

Moreover, in the second embodiment, image data may be scaled up/down in accordance with the size of the recording medium that was decided on as the feeding state in step S1503.

As described above, the second embodiment not only achieves the effects described in the first embodiment, but also allows the user to configure print setting related to the direction of the sheet through a small number of operations on a smartphone screen.

### Third Embodiment

The second embodiment has described the example in which the direction of a sheet is decided on based on the tilt 703 of the smartphone 101. In contrast, a third embodiment describes an example in which print setting is decided on in accordance with multiple occurrences of proximity between the smartphone 101 and the printing apparatus 102. It should be noted that configurations and processes that have the same functions as those of the first embodiment are given the same reference signs thereas, and a description of elements that are not different from those of the first embodiment in terms of configuration and function is omitted.

The apparatus configurations shown in FIGS. 1, 2 and 3 and the flowchart shown in FIG. 4 according to the first embodiment are applicable to the present embodiment. In step S902 of FIG. 9, the CPU 201 stores time at which NFC was established in the RAM 203 as first proximity time, in addition to executing relevant processing according to the first embodiment. FIG. 11 is also applicable to the present embodiment, except that steps S1102 and S1103 are omitted.

FIG. 16 shows a correspondence table 1601 in which color setting is associated with the tilt 703 of the smartphone 101 at the time of second proximity (second proximity state) that follows first proximity (first proximity state). When the tilt 703 of the smartphone 101 is 0 degrees to 44 degrees, 135 degrees to 224 degrees, and 315 degrees to 359 degrees, full-color is decided as the color setting; otherwise, monochrome is decided as the color setting.

In the third embodiment, the user first brings the smartphone 101 into contact with the printing apparatus 102 (first proximity), and then moves the smartphone 101 away from the printing apparatus 102. Thereafter, the user tilts the display unit 207 of the smartphone 101 in the direction of gravity, and then brings the smartphone 101 into contact with the printing apparatus 102 again (second proximity).

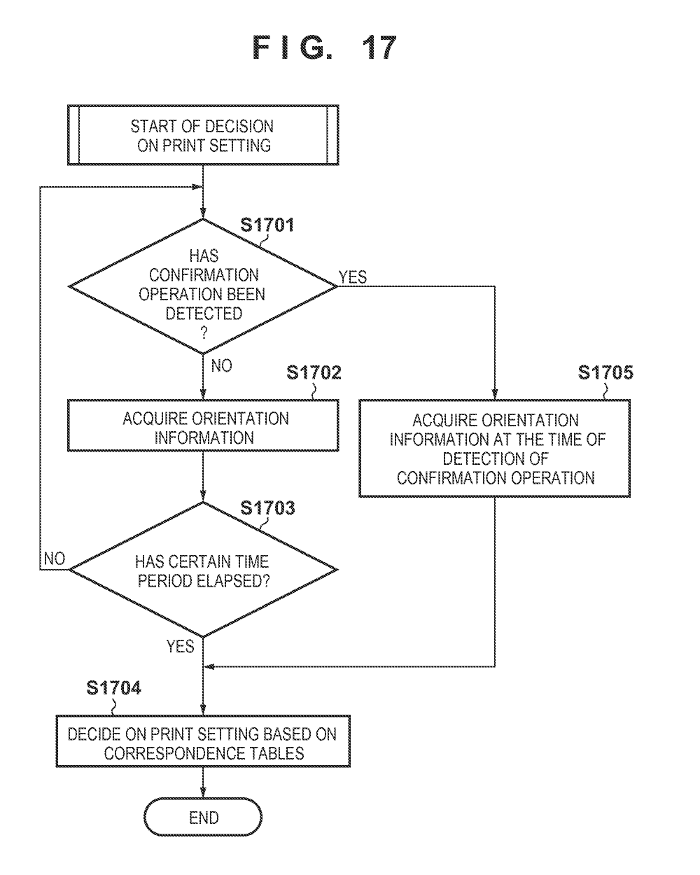

FIG. 17 shows a flow in which the smartphone 101 decides on print setting in step S904 in the third embodiment. With the aim of explaining the flow of FIG. 17, it will be assumed that the tilt 703 of the smartphone 101 that was acquired as the orientation information in step S903 is regarded as orientation information A.

In step S1701, the CPU 201 detects whether or not a confirmation operation for the print setting has been executed, that is to say, whether or not NFC 103 is reestablished after being disconnected once. Furthermore, the CPU 201 stores, in the RAM 203, gravitational acceleration along the axis in the direction perpendicular to the screen of the smartphone 101 as orientation information B. Orientation information B having a negative value indicates the state where the display is facing the direction of gravity.

If the CPU 201 has not detected the confirmation operation in step S1701 (NO of step S1701), processing proceeds to step S1702. In step S1702, the CPU 201 causes the acceleration acquisition unit 212 to acquire gravitational acceleration along the axis in the direction perpendicular to the screen of the smartphone 101 as orientation information C, and stores the same in the RAM 203. While step S1702 is repeated multiple times, the CPU 201 updates the orientation information C only if a value of a difference between the orientation information C (gravitational acceleration) acquired in step S1702 and the orientation information B (gravitational acceleration) exceeds a value of a difference between the orientation information C stored in the RAM 203 and the orientation information B.

In step S1703, the CPU 201 acquires a time period that has elapsed since the detection of the confirmation operation was started by calculating a difference between the first proximity time and the current time with reference to the RAM 203, and determines whether or not a predetermined time period has elapsed. If the time period that has elapsed is smaller than a certain value (certain time period) (NO of step S1703), processing returns to step S1701. If the time period that has elapsed is equal to or longer than the certain time period (YES of step S1703), it is determined that reconnection has not been established, and processing proceeds to step S1704.

On the other hand, if the confirmation operation has been detected in step S1701 (YES of step S1701), the CPU 201 stores time at which reconnection was detected in the RAM 203 as second proximity time. Next, in step S1705, the CPU 201 stores the tilt 703 of the smartphone 101 in the RAM 203 as orientation information D, and proceeds to step S1704.

In step S1704, the CPU 201 refers to the orientation information A, the orientation information B, the orientation information C, the orientation information D, and the second proximity time in the RAM 203. Here, if the second proximity time is not stored in the RAM 203, the CPU 201 discards the orientation information B and the orientation information C. The CPU 201 decides on print setting by acquiring sheet direction setting from the correspondence table 1301 based on the orientation information A, as well as color setting from the correspondence table 1601 based on the orientation information D. If one of the orientation information B and the orientation information C has a positive value while the other has a negative value, duplex printing is decided as print setting. Provided that the orientation information A is 80 degrees, the orientation information B is 5, the orientation information C is −1, and the orientation information D is 80 degrees, the following are decided as print setting: landscape sheet direction, duplex, and monochrome.

In step S1701, the confirmation operation for the print setting may be detection of proximity by various types of sensors in the proximity information acquisition unit 210 (output from one of the acceleration sensor, the proximity sensor, the luminance sensor, and the magnetic sensor, or from any combination thereof), instead of reconnection of NFC 103.

The orientation information B and the orientation information C used in step S1704 are not limited to gravitational acceleration along the axis in the direction perpendicular to the screen of the smartphone 101, and may be vibration or shock applied to the smartphone 101, tilt, or the number of occurrences of a proximity state.

The print setting that is decided on in step S1704 is not limited to duplex setting and color/monochrome setting, and may be print setting for printing multiple pages per sheet and the like.

The print setting that is decided on in step S1704 may include cancellation instruction information for cancelling a print job that has already been transmitted to the printing apparatus 102. In this case, the printing apparatus 102 receives the print job including the cancellation instruction information in step S1104, and cancels, out of print jobs that are being processed, a print job including the same job name and the same user name as the received print job in step S1105.

The user can freely edit and register the correspondence table 1301 and the correspondence table 1601, which are referred to in step S1704, via the smartphone 101 or the printing apparatus 102 that functions as a setting unit.

As described above, the third embodiment not only achieves the effects described in the first and second embodiments, but also allows the user to configure duplex print setting through a few operations on a smartphone screen. Furthermore, as proximity between the smartphone 101 and the printing apparatus 102 is used as a confirmation operation for print setting, print setting can be configured without impairing usability, even under a situation in which the user has difficulty operating the operation unit 206 or viewing the display unit 207.

In addition, while NFC is adopted as short range wireless communication in the first to third embodiments, NFC may be replaced by another short range wireless communication, such as Bluetooth (registered trademark), short range infrared communication, and WUSB (wireless USB).

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-062861, filed Mar. 25, 2013, which is hereby incorporated by reference herein in its entirety.

What is claimed is:

1. An information processing terminal provided with a communication unit, comprising:
an acquisition unit configured to acquire orientation information related to an orientation of the information processing terminal;
a decision unit configured to decide on print setting related to a printing apparatus based on the orientation information;
a generation unit configured to generate a print job based on the print setting; and
a transmission unit configured to transmit the print job to the printing apparatus via the communication unit.

2. The information processing terminal according to claim 1, wherein
the orientation information is calculated based on output from one of an acceleration sensor, a proximity sensor, a luminance sensor, and a magnetic sensor, or from any combination thereof.

3. The information processing terminal according to claim 1, wherein the decision unit decides on the print setting based on a correspondence table in which the orientation information is associated with the print setting.

4. The information processing terminal according to claim 3, further comprising a setting unit configured to set the correspondence table.

5. The information processing terminal according to claim 1, further comprising a reception unit configured to receive apparatus information of the printing apparatus via the communication unit,
wherein the decision unit decides on the print setting further based on the apparatus information.

6. The information processing terminal according to claim 5, wherein the apparatus information includes a feeding state of a recording medium stored in a feeding unit of the printing apparatus and an direction of a print image.

7. The information processing terminal according to claim 5, wherein the print setting includes at least one of a direction of a recording medium used for printing, color setting, and a layout of a print image printed on the recording medium.

8. The information processing terminal according to claim 1, further comprising a storage unit configured to store first proximity time, second proximity time, and the orientation information of the information processing terminal between the first proximity time and the second proximity time, the first proximity time being time of detection of a first proximity state, the second proximity time being time of detection of a second proximity state that follows the first proximity state, the first proximity state and the second proximity state being proximity states where the information processing terminal and the printing apparatus are in proximity to each other within a predetermined distance range via the communication unit,
wherein the decision unit decides on the print setting further based on the orientation information of the information processing terminal between the first proximity time and the second proximity time.

9. The information processing terminal according to claim 1, wherein the decision unit decides on the print setting further based on the number of occurrences of a proximity state where the information processing terminal and the printing apparatus are in proximity to each other within a predetermined distance range via the communication unit.

10. The information processing terminal according to claim 1, wherein the print job includes instruction information for cancelling a print job that has already been transmitted to the printing apparatus.

11. An information processing system including a printing apparatus and an information processing terminal that are provided with respective communication units for performing short range communication,
the information processing terminal including
an acquisition unit configured to acquire orientation information related to an orientation of the information processing terminal;
a generation unit configured to generate a print job including the orientation information acquired by the acquisition unit; and
a transmission unit configured to transmit the print job to the printing apparatus via the communication unit,
the printing apparatus including
a reception unit configured to receive the print job from the information processing terminal via the communication unit; and
a decision unit configured to decide on print setting related to the printing apparatus based on the orientation information included in the print job.

12. A control method for an information processing terminal provided with a communication unit, comprising:
an acquisition step of acquiring orientation information related to an orientation of the information processing terminal;
a decision step of deciding on print setting related to a printing apparatus based on the orientation information;
a generation step of generating a print job based on the print setting; and
a transmission step of transmitting the print job to the printing apparatus via the communication unit.

13. A computer-readable storage medium having stored therein a program for causing a computer to control an information processing terminal provided with a communication unit, the program causing the computer to function as:
an acquisition unit configured to acquire orientation information related to an orientation of the information processing terminal;
a decision unit configured to decide on print setting related to a printing apparatus based on the orientation information;
a generation unit configured to generate a print job based on the print setting; and
a transmission unit configured to transmit the print job to the printing apparatus via the communication unit.

14. An information processing terminal provided with a communication unit, comprising:
an acquisition unit configured to acquire orientation information related to an orientation of the information processing terminal;
a generation unit configured to generate a print job including the orientation information; and
a transmission unit configured to transmit the print job to a printing apparatus via the communication unit.

15. A printing apparatus provided with a communication unit, comprising:
a reception unit configured to receive a print job from an information processing terminal via the communication unit; and
a decision unit configured to decide on print setting related to the printing apparatus based on orientation information included in the print job.

16. A control method for an information processing terminal provided with a communication unit, comprising:
an acquisition step of acquiring orientation information related to an orientation of the information processing terminal;
a generation step of generating a print job including the orientation information; and
a transmission step of transmitting the print job to a printing apparatus via the communication unit.

17. A control method for a printing apparatus provided with a communication unit, comprising:
a reception step of receiving a print job from an information processing terminal via the communication unit; and
a decision step of deciding on print setting related to the printing apparatus based on orientation information included in the print job.

18. A computer-readable storage medium having stored therein a program for causing a computer to control an information processing terminal provided with a communication unit, the program causing the computer to function as:
an acquisition unit configured to acquire orientation information related to an orientation of the information processing terminal;
a generation unit configured to generate a print job including the orientation information; and
a transmission unit configured to transmit the print job to a printing apparatus via the communication unit.

19. A computer-readable storage medium having stored therein a program for causing a computer to control a printing apparatus provided with a communication unit, the program causing the computer to function as:
a reception unit configured to receive a print job from an information processing terminal via the communication unit; and
a decision unit configured to decide on print setting related to the printing apparatus based on orientation information included in the print job.
